(19) United States
(12) Patent Application Publication
(10) Pub. No.: US 2006/0111976 A1
(43) Pub. Date: May 25, 2006

(54) System and methods of marketing, designing, manufacturing and packaging customized items

(76) Inventor: Ninel Pompushko, Chicago, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/274,080

(22) Filed: Nov. 15, 2005

Related U.S. Application Data
(60) Provisional application No. 60/628,160, filed on Nov. 15, 2004.

(51) Int. Cl. G06Q 30/00

(52) U.S. Cl. 705/14

(57) ABSTRACT

A system and methods for designing, manufacturing and packaging customized items are provided. In a preferred embodiment, the inventive system is utilized in a retail store for customizing apparel, such as t-shirts, where a customer can choose an item to be customized from various styles, sizes and colors of blank items, and a design, decal or lettering to be affixed on the item in a specific place. The retail store has a deli-style theme that is familiar to customers and is organized and provides unique opportunities for display and marketing of customized items.

This application claims priority pursuant to 35 U.S.C. 119(e) to co-pending U.S. Provisional Patent Application Ser. No. 60/628,160, filed Nov. 15, 2004, the entire disclosure of which is incorporated herein by reference.

### FIELD OF THE INVENTION

The present invention relates generally to customized items, such as custom-made t-shirts and other customized apparel. More particularly, the present invention is concerned with a system and methods of marketing, designing, manufacturing and/or packaging customized items such as custom-made t-shirts and the like.

### BACKGROUND OF THE INVENTION

Many items, such as t-shirts and other apparel, are designed by manufacturers who mass produce relatively large quantities of a specific item having a specific design, and distribute the quantities to retailers for sale to consumers. Retailers maintain an inventory of the item, as well as inventory of other similar items having different designs appealing to the particular consumer.

In many instances consumers desire to customize items being purchased rather than purchase pre-designed stock items. For example, consumers often purchase custom-made t-shirts for special occasions such as birthdays, bachelor/bachelorette parties, etc., for special use such as little league sports teams, etc., or simply to wear unique, one-of-a-kind, clothing. Nevertheless, systems and methods of customizing items, such as t-shirts and other apparel, of the prior art typically are unorganized and awkward for persons desiring to purchase customized items. In addition, most customized items are designed by consumers that are customizing the t-shirts for a specific occasion or purpose (i.e. for a little league team) who already have determined basic design ideas or even fully completed designs for the t-shirts prior to visiting the store. As a result, consumers who do not have predetermined design ideas do not typically purchase customized items or even visit customization stores, and instead purchase stock designs from retail locations. Therefore, it would be beneficial to provide a system of customizing items that is organized and familiar to consumers that desire to purchase customized items whether or not the consumers have predetermined customization ideas.

### SUMMARY OF THE INVENTION

An object of the instant invention is to provide a system of customizing items that is organized and familiar to consumers that desire to purchase customized items whether or not the consumers have predetermined customization ideas.

The objects of the instant accomplished through the use of a system and methods of designing, manufacturing and packaging customized items that result in the customization process becoming as comfortable and easy for consumers as purchasing non-customized, stock items. The instant invention utilizes a “deli-style” display system and menu boards for displaying various options (and pricing) available for customizable items to purchasers in a store or on the web. In a preferred embodiment of the instant invention, the items being customized are t-shirts that are purchased in a brick-and-mortar store. In this embodiment, blank t-shirts of various styles, colors, sizes, etc. are displayed in a display case for viewing and selection by consumers. Decals that can be pressed onto the selected blank t-shirt are displayed in categorized notebooks on butcher tables located in the center of the store. The purchaser selects the desired blank t-shirt and desired decal (or custom lettering or custom decal—collectively the “design”), and places an order at the counter/cash register indicating the t-shirt and design selections. The customer's order is taken at the counter and the t-shirt is made behind the counter pursuant to the customer's selections in front of the customer. The completed t-shirt is displayed to the customer for final approval, and the t-shirt is packaged in deli paper in the same manner in which a completed deli-sandwich is packaged, and the t-shirt is then placed in a bag or sack with a bag of chips, just like a deli-sandwich.

The instant invention simplifies and organizes the customization process. Customization options (i.e. color, size style, etc. of a t-shirt, and various decals and/or lettering) are presented to the customer in an organized manner that makes the selection process easier, more comfortable and more efficient. The customer's decision process is broken down into several steps making customization easier. In the embodiment of the instant invention in which a customized t-shirt is made, the selection of the blank t-shirt is separated from the selection of the design. The customer is assisted in the selection process by the menu boards, as well as by the arrangement of the store which automatically directs the customer through the various customization steps.

The packaging of the final customized item associates the item with a made-to-order convention with which customers are already familiar. This association increases the customer's level of comfort with the customization process and thus increases the customer's satisfaction. The packaging also provides a disassociation with the packaged item, which increases customer satisfaction by its unique nature and unique ability to disguise a gift, as well as increasing awareness of the store by making the packaging self-identifying to people already familiar with the store, or by sparking curiosity in people unfamiliar with the store.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is an overhead view of a layout of a retail store for customizing items in one embodiment of the instant invention.

FIG. 2 is a flow chart illustrating the method for customizing items in the retail store embodiment shown in FIG. 1.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

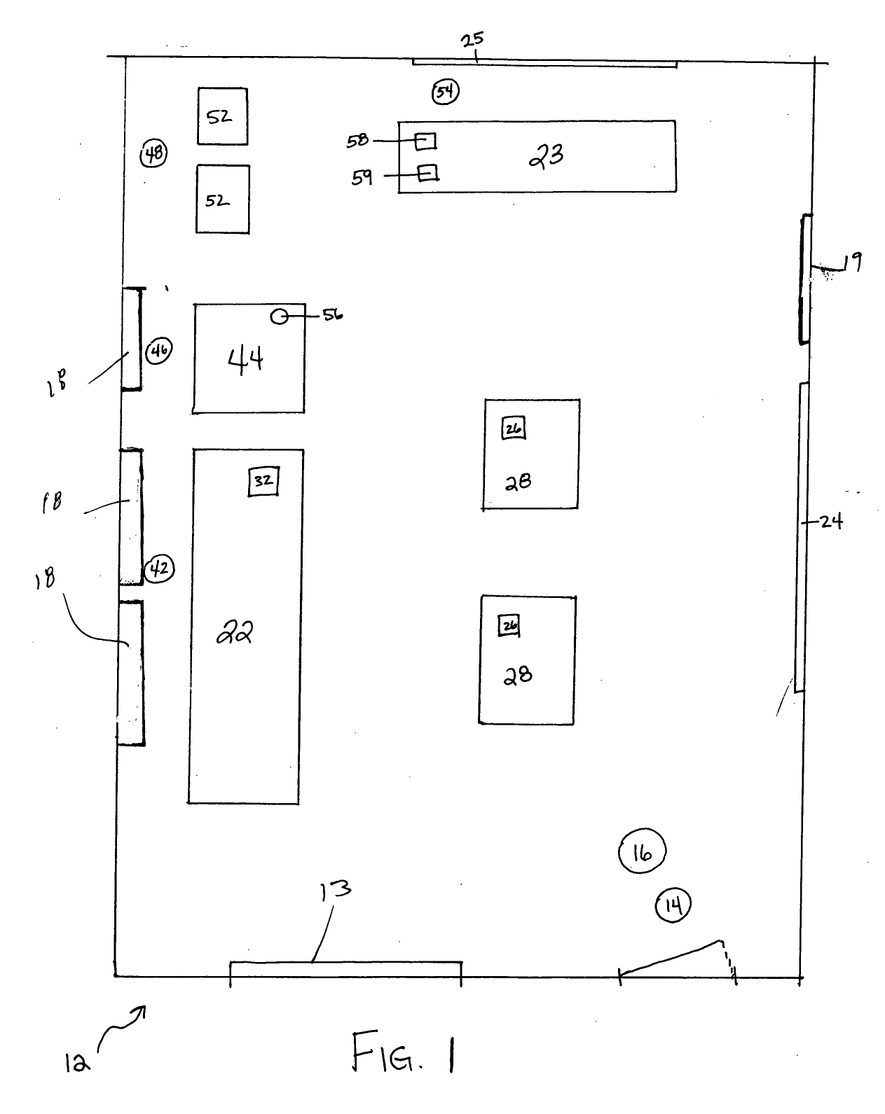

Embodiments of the invention, described below, provide a system of marketing, designing, manufacturing and/or packaging customized items which are typically mass produced or otherwise only customized based upon a predetermined design of the consumer, such as t-shirts and other apparel. In the embodiment shown in FIG. 1, retail store 12 resembles a deli-style restaurant in which customized t-shirts and apparel are marketed and sold. The components of the retail store create a welcoming and organized environment for a consumer that is designed in a familiar style and which allows the consumer to easily customize items regardless of whether or not the consumer has predetermined customization ideas for the items. As is shown in FIG. 1, the general components of retail store 12 include window display 13, butcher tables 28, primary deli case 22, secondary deli case 23, register 44, heat presses 52, menu boards 18, and wall displays 19, 24, and 25. In the described embodiment in which retail store 12 is a custom t-shirt store, the primary deli case contains blank t-shirts to display the various options for size, color, type, etc. of blank t-shirts, and the secondary deli case may contain additional blank t-shirts, or other items, such as alternative blank apparel items (shorts, boxers, etc.), sample customized items, kids items, etc. Wall displays 19, and 25 may include wood paneling background behind sample blank t-shirts, as well as samples of customized t-shirts, and wall display 24 may include displays such as visiting celebrity autographs (or mock celebrity autographs), framed decals and other items that provide a familiarity to consumers with a made-to-order deli style purchasing process. Window display 13 of the described embodiment includes shelving displaying bags of potato chips in the lower portion of the window, and sausages (or t-shirts rolled up to resemble sausages) in the top part of the window. The display of sausages and other food products commonly associated with a deli, provide an association with a convention of ordering and selecting items that are made to order or customized, with which the customer is already familiar. In addition, the disassociation between the window display and the customized items (t-shirts) attracts customers that are curious about the store. In another embodiment of the instant invention, window display 13 includes a television monitor that is connected to a DVD player, the DVD plays in a continuous loop and includes photographs of customer's holding up their t-shirts that they have had custom made at retail store 12. The television monitor faces outward, to attract attention to the store. In yet another embodiment of the instant invention, window display 13 includes sample t-shirts having phrases relating to current events, for example during the World Series window display 13 may include a t-shirt reading “socks in the city”, and on St. Patrick's day window display 13 may include a t-shirt reading “kiss me I'm Irish”.

In the preferred embodiment discussed herein, retail store 12 includes the following employees: hosts (or greeters) 16, wait-staff 42 and/or 46, t-shirt “chefs” 48, and wrappers 54. Although described herein as individual employees with separate job assignments, it will be appreciated that the job assignments of one or more employees may be performed by a single employee, and the specific locations within retail store 12 of employees may vary from the locations shown in FIG. 1. For example, although shown in FIG. 1 located near the entrance of retail store 12, the job assignments of host/greeter 16, may be performed by one of wait-staff employees 42 or 46. In another example, all job assignments may be performed by a single employee within retail store 12. Employee jobs assignments for retail store 12 are as follows:

1) HOSTS
a) Greet customers
b) Point customers to areas of interest
c) Answer questions
d) Give information about “wait time”

2) WAIT-STAFF
a) Greet customers
b) Help customers understand Order Forms
c) Help customers design t-shirt
d) Answer questions
e) Pull decals and shirts for t-shirt Chefs
f) Explain orders to t-shirt Chefs if there are questions

3) T-SHIRT “CHEFS”
a) Make t-shirts
b) Show t-shirts to customers upon completion

4) WRAPPERS
a) Take completed t-shirt from Chef
b) Suggest a gift tag for gifts
c) Wrap items in butcher paper
d) Place items in bags with chips, etc.
e) Staple gift card, or t-shirt Deli, personalized card, to bag
f) Say thank you and goodbye to the customer
   Regardless of specific job assignments, all employees of retail store 12 wear aprons for easy access to order forms and pens (especially host 16 and/or wait-staff 42 and 46), and for easy access to t-shirt making utensils such as scissors, hole punch, etc. (especially chefs 48).

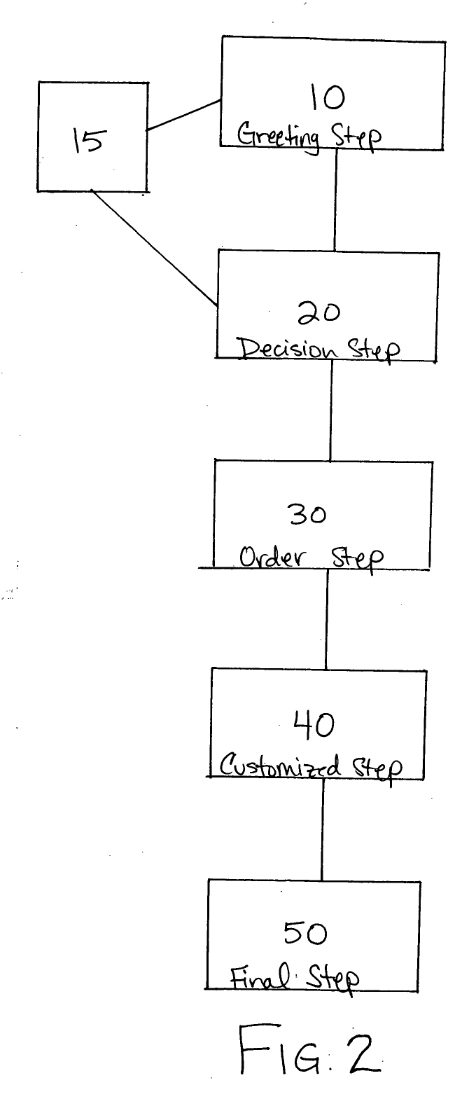

Referring to FIG. 2, a preferred system of marketing, designing, manufacturing and/or packaging customized items in retail store 12 utilizes the following steps, which shall be discussed below in further detail: customer greeting step 10; customer decision step 20; customer order step 30; item customization step 40; and final packaging step 50. Generally, in greeting step 10, customer 14 enters retail store 12 and encounters host/greeter 16 who welcomes customer 14 to the store and provides assistance to customer 14. If customer 14 is already familiar with the ordering process of retail store 12, customer 14 will move on to decision step 20. Otherwise, if customer 14 is unfamiliar with the ordering process, host 16 informs customer 14 as to how the ordering process works in assistance step 15. In addition to, or in lieu of, the assistance provided by host 16 to customer 14, painted signs are located throughout retail store 12 to guide customer 14 through the ordering process. Host 16, and/or wait-staff employee 42, will refer a customer that is unfamiliar with the ordering process to various display boards, such as display 19 which includes a menu-board (or pizza-board, etc.) that displays the various style and color options of letters that are available for use on blank t-shirts. In the preferred embodiment, letter options may also be displayed on top of primary deli case 22, or in the deli case, for easy viewing when customer 14 is placing an order. Host 16, and/or wait-staff employee 42, will also refer unfamiliar customer 14 to the various styles and colors of t-shirt options (and other apparel options) that are displayed in deli cases 22 and 23 and also on wall displays 19 and 25, and to butcher tables 28, which include one or more menu books 26 of decal options that a customer may select for use on the customized t-shirt. Displaying items by color and style in deli-cases 22 and 23 allows customer 14 to easily identify the initial options as to what items are available for customization. Displaying samples of items by style, size and color on wall displays 19 and 25 allows customer 14 to feel and test the items to further assist with the customer's selection.

Decision step 20 generally includes first picking out the item to be customized, such as a t-shirt or other apparel item from the various options shown in deli cases 22 and 23 (and also shown on wall displays 19 and 25), and then selecting the type of lettering, design, saying, or decal to be placed on the item. Menu books 26 show the different types of decals and lettering and samples of previous items made. In a preferred embodiment, each menu book 26 includes an identification number associated with each decal for use in ordering and is organized by theme, such as: a “Kid's Menu” book which includes child-appropriate decals; a “Family Menu” book which includes both child appropriate and adult appropriate decals; an “Adult Menu” or “Adult Only” book which includes decals that are not suitable for children; a “mini-meals” menu which includes smaller decals; and a “Fresh from the Deli Recipes” book which includes photo of t-shirts made by previous customers and the customers that made them. Menu books 26 are located on butcher tables 28, which are located in the middle of retail store 12, such that multiple customers 14 are encouraged to stand close together around tables 28 and discuss ideas for making customized t-shirts. In one embodiment of the instant invention, a television monitor may also be located on a wall in retail store 12 (such as on a wall behind one of the deli cases). As is discussed above with respect to window display 13, the television monitor is connected to a DVD player that runs in a continuous loop displaying photographs of customers holding up their t-shirts. The monitor in the store gives customers ideas in the same or similar manner as the “Fresh from the Deli Recipes” book.

Order step 30 generally includes customer 14 taking a ticket from a “Take-a-Number” machine, and placing the customized order by writing information on an order form that is given to one of wait-staff employees 42 or 46 when the customer's number is called. The customer is aided in the order step by menu board 18 which generally includes a guide to the process and pricing of various apparel items. For example, menu board 18 includes pricing information for “men's and woman's” apparel items; “kid's meals” (i.e. baby or toddler apparel items); “Choice Cuts” (i.e. pet t-shirts, underwear, etc.); and “ALA CART” items (i.e. pricing for decals and pricing for lettering used on t-shirts or other apparel items). Menu board 18 will change as new items are offered and as prices fluctuate. In order step 30, customer 14 may select from “Deli Specials” that are pre-designed t-shirts (or other apparel items) samples of which are displayed on the wall behind deli cases 22 and 23, customer 14 may design his/her own customized t-shirt (or other item) in the manner discussed below, or customer 14 may place an order to make a t-shirt using the customer's own custom image, such as using a digital transfer. Examples of “Deli Specials”, include t-shirts (or other items) that are displayed on the Special's Board so as to be relevant to current events, such as t-shirts that include the phrases “FREE MARTHA STEWART”, or “FEED KATE MOSS”, etc. Although such t-shirts are pre-designed, if customer 14 desires to make a Deli Special, the t-shirt is still made “fresh” or “to order” after the customer selects the style, size, color, etc. of the blank shirt on which to use the Deli Special design.

Order step 30, shall now be described in which customer 14 is ordering a customized item, such as a customized t-shirt. In order step 30 customer 14 fills out an order form 32. The customer 14 will supply the following information on the order form 32: name (used to group multiple orders by the same customer together, and/or to establish a relationship with the customer), cellular phone number (used in the event the customer leaves the store while the t-shirt is being made and questions about the design come up), category of item (i.e. men, woman, kid, baby, etc., as shown on menu board 18), style and color (as shown in deli cases 22 and/or 23, and on wall displays 19 and/or 25) of apparel to be customized, decal number and description (as found in menu books 26, if a decal is to be used), design, lettering (including font, size, and color), and where the location on the customized apparel of the design, decal, and/or lettering. Customer 14 matches the letter style (font) and color desired to the correct letter style and color on the order sheet by circle the appropriate selection on order form 32. Customer 14 is then prompted on order form 32 to write out any desired saying to be included on the customized item on two blank t-shirts drawings located on order form 32. In this manner the customer specifies the desired placement of the saying (phrase), and the correct spelling of all words. The first t-shirt drawing on order form 32 represents the front side of a t-shirt being customized, and the second t-shirt drawing represents the back of the t-shirt being customized. If desired, customer 14 may write on the front and/or the back of a t-shirt, with identical phrases, different phrases, or nothing at all.

During item customization step 40 customer 14 waits in the store while a worker fulfills the order made by order form 32. The design is pressed onto the item and the product is a customized item that the customer just designed. In customization step 40 customer 14 waits for the number selected from the “Take-a-Number” machine, to be called by the wait-staff (42 or 46) and then the gives order form 32 to the wait-staff member (42 or 46). The staff member 42 reads the customer's order form 32 back to customer 14 for clarity and verification. The wait-staff member 42 retrieves the blank apparel item to be customized and any and all decals and lettering. In most cases, larger or additional quantities (than are contained in deli cases 22 and 23) of blank apparel items are stored behind deli cases 22 and 23 on restaurant style shelving, with the items separated by style, size and color. In most cases the blank item will be taken from the shelving, so as to leave the display in deli cases 22 and 23 intact; however, if necessary, blank items may be taken directly from deli cases 22 and 23. Wait-staff member 42 or 46 holds up the blank item to verify with customer 14 that it is in fact the correct size, style, color, etc. If customer 14 wants a decal the wait-staff get the decal, put it together with the shirt, and brings all items to register 44. One of wait-staff members 42 or 46 rings customer 14 up at register 44 and customer 14 pays for the customized item. Customer 14 is informed by the wait-staff of approximate wait time/production time on the order (usually 5-20 minutes).

In one embodiment of the instant invention, a restaurant-style computer is utilized as register 44 in which wait-staff member 42 or 46 rings in the customer's orders on a keypad and it automatically comes up in the “Kitchen area” and received by the t-shirt chefs 48. In another embodiment, the wait-staff member (42 or 46) alerts chefs 48 that there is another order in cue by ringing a bell located on the deli counter and proclaiming, “ORDER UP!” when customer 14 is handed a receipt for the order. In such an embodiment, the wait staff member, 42 or 46, gives order form 32 to T-shirt Chef 48, or otherwise delivers the order slip to chefs 48 using a conveyer or similar order delivery mechanism as is typically used in deli and other restaurant settings. T-shirt Chef 48 makes the customized item using heat press 52, and then stabs order form 32 through a spindle 56 and calls out the customer's name and holds up the completed customized item for inspection by customer 14. When customer 14 is satisfied, t-shirt Chef 48 hands the customized item to wrapper 52.

In Final wrapping/packaging step 50, the item is wrapped and tagged as if it is a food order and is given to the customer with a store logo napkin and a bag of deli-style chips. In final packaging step 50 wrapper 52 asks customer 14 if the customized item is a gift. If the item is a gift then wrapper 52 gives customer 14 gift tag 58 (in the form a restaurant “guest check”) to write out a personalized message that will be stapled or otherwise fastened to the final gift bag. If the customized item is not a gift then wrapper 52 will write the name of customer 14 on deli tag 59 (also in the form a restaurant “guest check”). In a preferred embodiment, when wrapper 52 writes the name of customer 14 on the Deli Tag, he/she also includes a special customized message, such as “Thank you Mary!—The T-Shirt Deli, Co”, or if the customer is expecting a baby “Congratulations, Mary !! The T-Shirt Deli, Co” This establishes a neighborhood type feel and a relationship with the customer.

While the customer is writing out a gift tag, in the case of a gift, or otherwise to complete the packaging, wrapper 52 wraps the item in butcher paper and seals it with a deli-style “Weight Sticker” that identifies the name of the store. For example, the weight sticker may read “T-SHIRT DELI KOSHER STYLE”, where the name of the store is “T-Shirt Deli”. Wrapper 52 writes the name of the person receiving the item in the “weight area” (i.e. the area in which the weight of deli meat is typically listed on a deli-style weight sticker) of the sticker. Then various other “meat-type” stickers (i.e. stickers traditional associated with packaged deli-meats) are placed around the main Weight Sticker, including for example a sticker identifying the website address of the store that resembles a meat-type sticker in its fluorescent color and style. Wrapper 52 then takes the freshly wrapped customized item and places it into a paper bag or doggie bag, adds a bag of potato chips and a napkin with the logo and business hours of retail store 12 on it. If the item is not a gift wrapper 52 will include a to-go menu with styles and prices and a fax-in order form in the bag. Wrapper 52 attaches gift tag 58 or guest check/deli tag 59 on the bag, delivers it customer 14, and thanks the customer by name.

The packaging of the instant invention acts as viral marketing. A gift from retail store 12 is surprising. Gift receivers are given a gift that looks like it is food and are surprised to find that the gift is actually a personalized t-shirt (or other apparel item). They remember how excited they were to get the gift and want to give a similar gift to someone else. With respect to gifts for birthdays, showers, bachelorette party, baby's first birthday, basically any occasion where there is a group of people standing around a person who is opening a gift: the wrapping is built in marketing; when you receive a gift wrapped in butcher paper, you know it's from retail store 12; if a person opens a gift from retail store 12, in a crowded restaurant, bar, stadium, etc., everyone around can see that the gift is from the store without seeing any printed logo material, etc. If a person seeing the gift is not familiar with the store, the unique packaging sparks interest in learning about the store. A sticker identifying the store is placed on every wrapped package and a napkin with the address and phone number of the store is placed in every bag. This is extremely important because the gift receiver can come to the store, or shop online.

Gift Certificates may also be sold for retail store 12 (typically in any amount staring from $25 and up). In a preferred embodiment, gift certificates are made out on a Guest Check with the, name of the gift receiver. The gift certificates are then wrapped up in butcher paper and with the ‘Weight Sticker’, a Blank Deli Sticker that says the name of the receiver, and a sticker with the store local address. The gift certificates are then placed into a small doggie bag with a gift message from the giver stapled to the bag.

In another preferred embodiment of the instant invention, customized t-shirts are delivered by a special fleet of store Vehicles and Bike Messengers. For example, if something particularly interesting happens at work one day, say an ad agency wins a big account, a Creative Director may call his/her local store, and ask them to make up t-shirts for the winning team. For an extra fee, the t-shirts will be delivered, hot and wrapped, straight to the lucky winners, that same afternoon. Another preferred embodiment of the instant invention utilizes a catering truck that can make t-shirts (an other apparel items) on the spot at sporting events, concerts, rallies, and other events or venues in which custom t-shirts might be desirable.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of marketing customized apparel items, the method comprising:
displaying blank apparel items in an organized manner to represent to a customer a plurality of blank item options; and
providing said customer a plurality of customization item options for use with a selected one of said blank item options.

2. The method as claimed in claim 1 further comprising the step of locating said blank apparel items in an environment that is disassociated with the sale of apparel items.

3. The method as claimed in claim 2 wherein said locating step further comprises the step of locating said blank apparel items in a retail location that is typically associated with the sale of food items.

4. The method as claimed in claim 3 wherein said locating step further comprises the step of positioning said blank apparel items in a deli-style display case.

5. The method as claimed in claim 3 wherein said locating step further comprises the step of positioning food items in a window display.

6. The method as claimed in claim 5 wherein said food items are sausages.

7. The method as claimed in claim 6 where said sausages comprise t-shirts rolled to resemble meat sausages.

8. The method as claimed in claim 5 wherein said food items are potato chips.

9. The method as claimed in claim 2 wherein said displaying step further comprises the step of positioning said blank apparel items in a deli-style display case.

10. The method as claimed in claim 1 wherein said providing step further comprises the step of organizing said plurality of customization item options by theme in one or more menu books.

11. The method as claimed in claim 1 wherein said blank apparel items comprise t-shirts and wherein said t-shirts are organized according to style, size and color to result in said blank item options.

12. The method as claimed in claim 1 wherein said customization item options comprise a plurality of designs that are capable of being affixed to a selected one of said blank item options.

13. The method as claimed in claim 12 wherein said designs comprise decals.

14. The method as claimed in claim 12 wherein said designs comprise letters.

15. The method as claimed in claim 12 wherein said designs comprise letters and decals.

16. A method of marketing customized items, the method comprising:
displaying blank items in an organized manner to represent to a customer a plurality of blank item options; and
providing to said customer a plurality of customization item options for use with a selected one of said blank item options.
